(19) United States
(12) Patent Application Publication
(10) Pub. No.: US 2015/0336220 A1
(43) Pub. Date: Nov. 26, 2015

(54) RUNNING GEAR SYSTEM FOR PORTABLE WIRE FEEDER

(71) Applicant: Illinois Tool Works Inc., Glenview, IL (US)

(72) Inventors: Mark Richard Christopher, Neenah, WI (US); John Walter Lundin, Appleton, WI (US); Troy Douglas Wilson, Appleton, WI (US)

(73) Assignee: Illinois Tool Works Inc., Glenview, IL (US)

(21) Appl. No.: 14/285,793

(22) Filed: May 23, 2014

(51) Int. Cl. B23K 37/02; B62B 5/00; B62B 1/00; B23K 9/133

(52) U.S. Cl. CPC B23K 37/0294; B23K 9/133; B62B 5/0083; B62B 1/008

(57) ABSTRACT

A running gear system for a portable wire feeder case is disclosed that includes a plurality of wheel assemblies configured to rotate between a first retracted position and a first deployed position, a handle configured to extend between a second retracted position and a second deployed position, and a retractable support, wherein the plurality of wheel assemblies and the retractable support are configured to cooperatively support the portable wire feeder case in a horizontal orientation.

### BACKGROUND

The present disclosure relates generally to the field of wire feeders and/or welding systems. More specifically, the invention relates to running gear for a welding wire feeder.

In certain applications, a welding wire feeder mechanism or wire feeder may be used to feed a welding wire through a torch to a molten weld location in front of the tip of the torch. In many applications, it may be desirable to move the wire feeder to a remote location or simply to a different location in a work area. Unfortunately, certain conventional wire feeders may be designed as stationary devices intended to remain within a particular work area. These wire feeders are bench or open type feeders designed for indoor use and are too large and heavy for single person transport. In general, the parts to be welded are brought to the feeder. Additionally, portable feeders may be very heavy and/or large, which makes the portable feeders cumbersome and difficult to manually transport to multiple welding work sites. Portable feeders are used when the parts being welded are too large to move efficiently. In such circumstances, the feeder is moved about the structure being welded. Examples include ships, bridges, water towers, etc.

### BRIEF DESCRIPTION

Embodiments of the present disclosure include a system including a portable wire feeder running gear system having at least one bracket configured to removably couple to a case of a portable wire feeder and a plurality of wheel assemblies coupled to the at least one bracket, wherein each of the plurality of wheel assemblies is configured to rotate between a first retracted position and a first deployed position.

In a second embodiment, a system includes a portable wire feeder case and a running gear system removably coupled to the portable wire feeder case. The running gear system includes a plurality of wheel assemblies, an extendable handle, and a retractable support, wherein the plurality of wheel assemblies and the retractable support are configured to cooperatively support the portable wire feeder case in a horizontal orientation.

In another embodiment, a system includes a running gear system configured to couple to a portable wire feeder case, wherein the running gear system includes a plurality of wheel assemblies configured to rotate between a first retracted position and a first deployed position, a handle configured to extend between a second retracted position and a second deployed position, and a retractable support, wherein the plurality of wheel assemblies and the retractable support are configured to cooperatively support the portable wire feeder case in a horizontal orientation.

### DRAWINGS

These and other features, aspects, and advantages of the present invention will become better understood when the following detailed description is read with reference to the accompanying drawings in which like characters represent like parts throughout the drawings, wherein:

FIG. 1 is a front perspective view of a portable wire feeder system having a wire feeder disposed in a case with a running gear system coupled to the case, in accordance with an embodiment of the present disclosure;

FIG. 2 is a rear perspective view of the case of FIG. 1 without the running gear system, in accordance with an embodiment of the present disclosure;

FIG. 3 is a rear perspective view of the case of FIG. 1 with the running gear system, illustrating the running gear system in a collapsed configuration, in accordance with an embodiment of the present disclosure;

FIG. 4 is a side perspective view of the case of FIG. 1 with the running gear system, further illustrating another embodiment of the system;

FIGS. 5A-5B are side perspective views of the case of FIG. 1 with the running gear system, further illustrating another embodiment of the system;

FIG. 6A is a perspective view of the case of FIG. 1 with the running gear system, further illustrating another embodiment of the system; and

FIG. 6B is a side view of the case of FIG. 1 with the running gear system, further illustrating another embodiment of the system.

### DETAILED DESCRIPTION

As discussed in further detail below, various embodiments of wire feeder running gear system are provided that enable a user to transport the wire feeder from one location to another. In general, the system may be used in any one of a variety of welding systems and applications, such as gas metal arc welding (GMAW, sometimes referred to as metal inert gas or MIG welding), gas tungsten arc welding (GTAW, sometimes referred to as tungsten inert gas or TIG welding), or stick welding applications, although the wire feeder itself is clearly most suited to GMAW applications (and similar metal or flux cored wire applications). The system has a number of embodiments each including a track or “dolly” system that couples to a case of the wire feeder to enable transfer of the wire feeder from one location to another. For example, the running gear system may include one or more brackets that attach a plurality of wheel assemblies to the wire feeder case. Additionally, the wheel assemblies may be configured to rotate and lock between a deployed position and a retracted position. During transfer of the wire feeder from one location to another, the wheel assemblies may be rotated outward and locked in the deployed position to enable use of the track system as a dolly or hand truck. When storing or placing the wire feeder in a more limited space, the wheel assemblies may be rotated inward and locked in a retracted position.

The running gear system for the wire feeder may include other features. For example, the running gear system may include a handle (e.g., a retractable handle) that may be extended and used when the track system is in the deployed position and the wire feeder is transferred from one location to another. Additionally, the running gear system may include a retractable support or “kickstand” to enable support of the welding wire feeder in a horizontal position. Furthermore, in certain embodiments, each of the wheel assemblies of the running gear system may include multiple wheels configured to enable pivoting of the wire feeder and running gear system over obstacles or other hindrances while transferring (e.g., rolling) the wire feeder from one location to another.

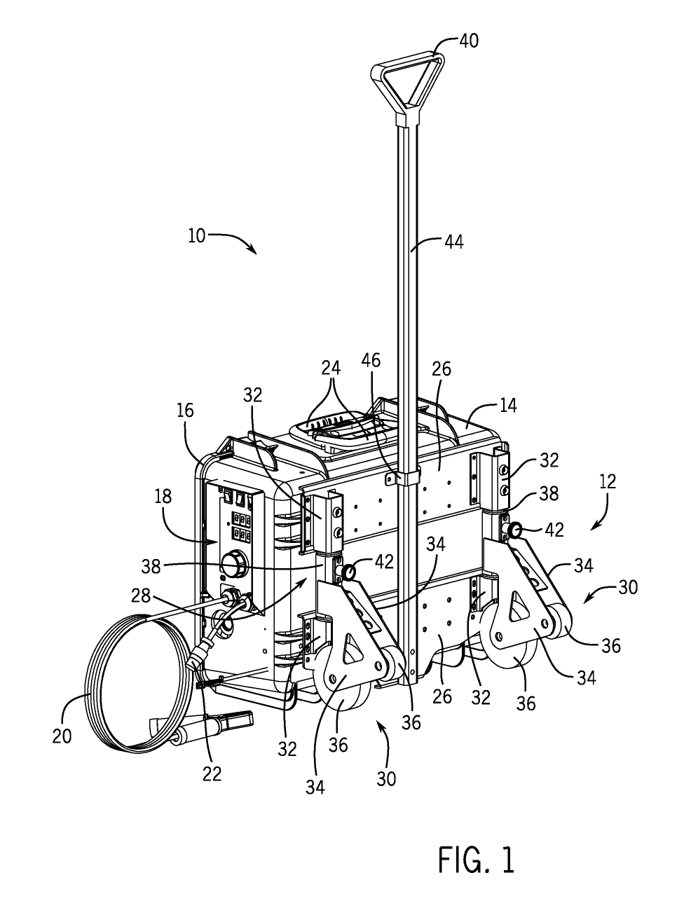

Turning now to the drawings, FIG. 1 is a perspective view of the portable wire feeder system 10 illustrating a running gear system 12 coupled to a case or suitcase 14, in accordance with a first embodiment. The case 14 may be made out of a variety of metallic and/or synthetic materials, which may form a soft shell or a hard shell to protect the internal components. These materials may include a plastic material, a durable fabric-like material, a metallic material, or a combination thereof. For example, the material may include polypropylene, polycarbonate, fiberglass, aluminum, etc. The case 14 may include a door 16 and hinge system that enables the user access to the internal cavity of the case 14. The case 14 and the door 16 may incorporate a locking system to secure the door in a closed position during transport and operation. For example, a snap-latch system or zipper system may be used to secure the door 16. A seal also may be disposed between the door 16 and the case 14 to create a watertight and/or airtight environment for the internal components.

A control panel 18 is located on a front side of the case 14 and enables the user to adjust and/or monitor welding parameters, the wire feed operation, and so forth. The control panel 18 includes a number of user control devices. In general, the control panel 18 may include a variety of knobs, switches, pushbuttons, electrical connectors, analog or digital gauges, analog or digital displays, or a combination thereof. These various control items on the control panel 18 may correspond to the wire feeder, the torch, the power supply, the gas supply, the heater, or a combination thereof. For example, the control panel 18 may include a jog/purge control, a trigger hold switch, a power control switch, a voltmeter, a wire speed/amperage meter, a wire speed control or wire feed control, a voltage control, and so forth. In addition, all or part of the control panel 18 may be detachable from the case 14. For example, the control panel 18 may snap fit into the case 14, such that it can be removed and operated independent from the case 14.

As will be appreciated, the case 14 houses a wire feeder and a wire supply. The wire supply is fed into the wire feeder that drives the weld wire out through a wire feed port and into a welding torch. Additional wire feeders, additional wire supplies, welding supplies, welding inspection tools, and portable power supplies are a few examples of welding components that may also be disposed in the carrying case 14. In general, when the case 14 is closed, the components within the case 14 may be protected from the surrounding environment. The case 14 also includes or is configured to couple with a welding ground cable 20 and a welding torch trigger connection cable 22. The welding ground cable 20 provides a ground for the system 10 and the welding torch trigger connection cable 22 provides a means to control the wire feeder from the welding torch. Additionally, a moisture removal system may be included in the case 14. The moisture removal system may include a heater or other moisture removal or exclusion techniques. The heater also may be configured to raise the temperature of the wire for a particular application. This may be particularly beneficial for cold environments and/or for increasing the ductility or other characteristics of the wire. In some embodiments, the case 14 may include temperature and/or humidity sensors coupled to the control panel 18 thereby facilitating feedback control of the heater. For example, it may be desirable to maintain a particular temperature or humidity level within the case 14, and the feedback sensors may trigger the heater to engage or disengage to maintain a particular environmental state within the case 14. In some embodiments, the case 14 may be airtight, watertight, or both, thereby creating a closed environment within the case 14. A hermetically sealed configuration of the case 14 may facilitate the environmental control within the case 14, while also keeping out moisture, dirt, or other pollutants from corrupting or damaging the wire feeder and other internal components.

As will be appreciated, the number of components contained within the case 14 may result in the case 14 being heavy and cumbersome to move from one location to another. While the case 14 may include handles 24 for moving the case 14 short distances, the portable wire feeder system 10 also includes the running gear system 12 coupled to the case 14. For example, the running gear system 12 may be mechanically coupled to the case 14 via mechanical fasteners, such as bolts. In certain embodiments, the running gear system 12 may include one or more components, such as a frame, that are integrally formed (e.g., molded or cast) with the case 14. In certain embodiments, the running gear system 12 may include a frame that is internal to the case 14, and other components of the running gear system may extend through the case 14 to couple to the internal frame. The running gear system 12 is configured to increase the ease of transporting the case 14 from one location to another. Additionally, the running gear system 12 includes additional features to increase convenience and improve the operability of the portable wire feeder system 10, as discussed in detail below.

In the illustrated embodiment, the running gear system 12 includes two mounting brackets (e.g., base plates) 26 that are coupled to a rear side 28 of the case 12. In other words, the mounting brackets 26 are coupled to a side of the case opposite the door 16 of the case 14. In certain embodiments, the mounting brackets 26 may be made from a durable material, such as steel, aluminum, or other metal. Additionally, the mounting brackets 24 may be fixed to the rear side 28 of the case 14 by mechanical fasteners, such as bolts, screws, rivets, or other suitable mechanical fastener. The mounting brackets 26 couple various components of the running gear system 12 to the case 14. For example, wheel assemblies 30 of the running gear system 12 are coupled to the case 14 via the mounting brackets 26 and U-brackets 32. In the illustrated embodiment, the U-brackets 32 are bolted to the mounting brackets 26, but in other embodiments the U-brackets 32 may be integrated (e.g., cast or welded) with the mounting brackets 26.

Each of the wheel assemblies 30 includes a pair of wheel brackets 34 having a triangular shape or configuration that cooperatively capture wheels 36 of the wheel assembly 30. For example, pins may extend through the wheels 36 and couple to the wheel brackets 24. In the illustrated embodiment, each wheel assembly 30 includes two wheels 36. However, in other embodiments, each wheel assembly 30 may include fewer wheels 36 (e.g., one wheel 36) or more wheels 36 (e.g., 3, 4, 5, or more wheels 36). The wheel brackets 34 are further connected to a respective sleeve 38 of each wheel assembly 30. The sleeve 38 of each wheel assembly 30 extends around a bar (not shown) of each wheel assembly 30 that extends through and is captured by the U-brackets 32. More particularly, the bars are captured and fixed to the mounting brackets 26 by the U-brackets 32. As will be appreciated, the sleeves 38 disposed about the bars may be configured to pivot and/or rotate relative to the bars. As a result, the position of the wheel assemblies 30 may be adjusted relative to the mounting brackets 24 and the case 14. However, in other embodiments, the position of the wheel assemblies 30 may be fixed relative to the mounting brackets 26. That is, the wheel assemblies 30 may be fixed in the deployed position shown in FIG. 1.

In the illustrated embodiment, the wheel assemblies 30 are shown in a rotated out or deployed position. As such, the case 14 may be pivoted (e.g., using a handle 40 of the running gear system 12) to position the wheel assemblies 30 underneath the case 14 and enable rolling of the case 14 across the ground. The wheel assemblies 30 may be held in the deployed position by respective knobs 42. For example, the knobs 42 may each include a spring disposed about a pin that engages with a hole formed in the rod to restrict movement of the wheel assembly 30. To release the wheel assembly 30, the knob 42 may be pulled outward to disengage the pin from the hole, and the wheel assembly 30 may be rotated inward to a retracted position.

As mentioned above, the running gear assembly 12 includes a handle 40 to enable pivoting, pulling, and rolling of the portable wire feeder system 10. The handle 40 couples to a stem 44 that extends from the handle 40 to the mounting brackets 26. The stem 44 is coupled to the mounting brackets 26 via U-brackets 46. In certain embodiments, the stem 44 may have a telescopic configuration. That is, the stem 44 may have multiple segments nested within one another to enable extension and collapsing of the stem 44 and the handle 40. For example, the stem 44 may be extended when a user moves (e.g., rolls) the portable wire feeder system 10 from one location to another with the running gear system 12, and the stem 44 may be collapsed when the portable wire feeder system 10 is stationary during a welding operation or when the portable wire feeder system 10 is stored. Furthermore, while illustrated embodiment includes one stem 44 extending from the handle 40 the mounting brackets 26, other embodiments may include other numbers of stems 44 (e.g., two stems 44).

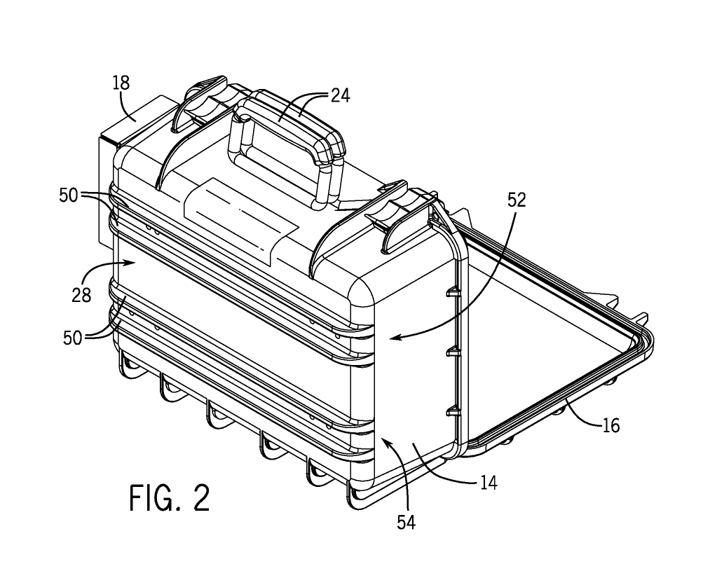

FIG. 2 is a rear perspective view of the case 14 of FIG. 1, illustrating the rear side 28 of the case 14 without the running gear system 12 coupled to the case 14. As mentioned above, the running gear system 12 is coupled to the case 14 via the mounting brackets 26 of the running gear system 12. More specifically, the mounting brackets 26 couple to the rear side 28 of the case 14. As shown in the illustrated embodiment, the rear side 28 of the case 14 includes rails 50 integrally formed with the rear side 28 of the case 14. In particular, the rear side 28 of the case 14 includes a first set 52 of two rails 50 and a second set 54 of two rails 50.

In certain embodiments, the mounting brackets 26 may be configured to couple to the rails 50 on the rear side 28 of the case 14. For example, one mounting bracket 26 may couple to the first set 52 of rails 50, and another mounting bracket 26 may couple to the second set 54 of rails 50. The mounting brackets 26 may couple to the rails 50 using mechanical fasteners (e.g., bolts), a friction fit, a snap fit, an interference fit, or other type of connection. In certain embodiments, the rails 50 may include holes (e.g., to receive bolts) or other features to enable connection of the mounting brackets 26 to the case 14. Each of the mounting brackets 26 may also include a geometry or contour configured to be disposed between two rails 50 in one of the sets 52 and 54 of rails 50. The geometry or contour may help guide a user to position the mounting brackets 26 in a proper or appropriate position against the rear side 28 of the case 14 when coupling the mounting brackets 26 to the case 14.

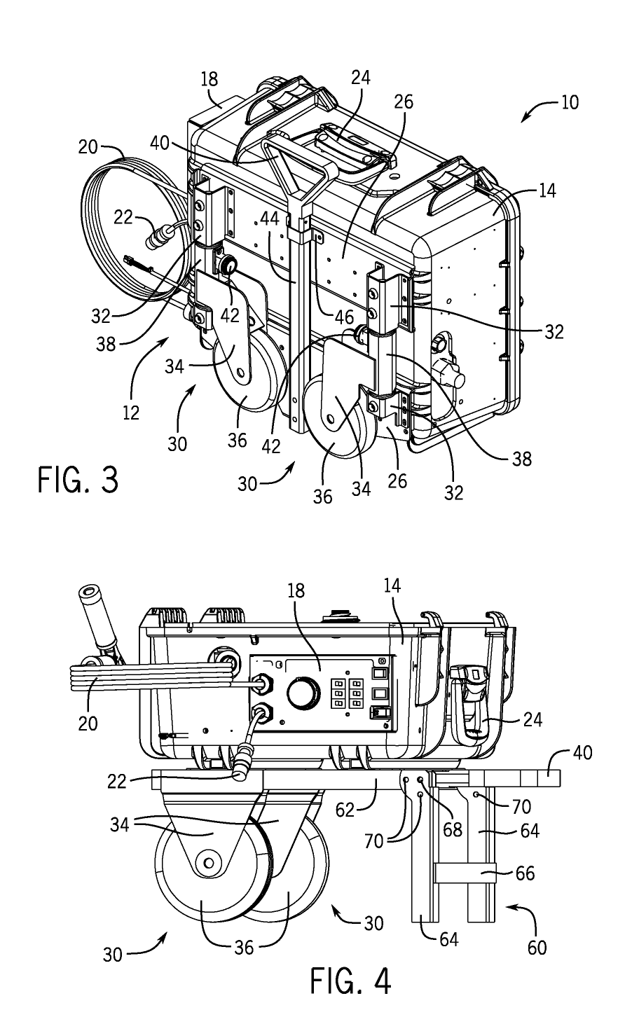

FIG. 3 is a rear perspective view of the portable wire feeder system 10, illustrating the running gear system 12 coupled to the case 14 with the running gear system 12 in a compacted or retracted position. As mentioned above, the running gear system 12 may be positioned in the compacted or retracted position when the running gear system 12 is not being used to simplify and improve transportation of the portable wire feeder system 12.

In the illustrated embodiment, each of the wheel assemblies 30 is shown in an inwardly-rotated or retracted position. As discussed above, the wheel assemblies 30 include sleeves 38 that rotate around bars retained by the U-brackets 32. Additionally, the wheel assemblies 30 may be held in the retracted position by the knobs 42, each of which include a spring disposed about a pin that engages with a hole formed in the rod to restrict movement of the wheel assembly 30. When the wheel assemblies 30 are inwardly rotated and retracted, the wheel assemblies 30 are conveniently stowed, thereby reducing the footprint of the running gear system 12 and reducing the likelihood that the wheel assemblies 30 make undesired contact with elements of the surrounding environment. For example, when the portable wire feeder system 10 is stored when not in use, the wheel assemblies 30 may be positioned in the retracted position to reduce the amount of space occupied by the portable wire feeder system 10. For further example, if an operator wishes to carry the portable wire feeder system 10 via the handles 24 in a restricted or narrow space (e.g., a stairway), the wheel assemblies 30 may be positioned in the retracted position to reduce the overall space occupied by the portable wire feeder system 10.

When the running gear system 12 is in the collapsed or retracted position, the stem 44 of the running gear system 12 is collapsed. As mentioned above, the stem 44 may include multiple telescopic segments, which enable the stem 44 to collapse and reduce the space occupied by the stem 44 and the handle 40. In certain embodiments, the telescopic segments may include features to enable retention of the telescopic segments in the retracted and/or deployed position. For example, the telescopic segments may include ball dents to hold the telescopic segments in place.

FIG. 4 is a side perspective view of the portable wire feeder system 10, illustrating the running gear system 12 having a retractable support or “kickstand” 60. Additionally, in the illustrated embodiment, the wheel assemblies 30 have a fixed configuration. That is, the wheel assemblies 30 are fixed in a deployed position. In the fixed configuration shown, the sleeves 38 may or may not be omitted from the running gear system 12. Instead, the wheel assemblies 30 may be fixed (e.g., bolted, welded, brazed, etc.) to bars 62 of the running gear system 12.

As will be appreciated, it may be desirable or convenient to position the portable wire feeder system 10 in a horizontal orientation, as shown in FIG. 4, during a welding operation. Accordingly, the running gear system 12 may include the retractable support 60, which is configured to support the portable wire feeder system 10 in a horizontal orientation. The retractable support 60 includes two support legs 64 and a cross brace 66. Each of the two support legs 64 is coupled to one of the bars 62 of the running gear system 12 by hinge pin 68 or other type of retainer. The hinge pin 68 enables the retractable support 60 to pivot relative to the bars 62 of the running gear system 12.

In the illustrated embodiment, the retractable support 60 is shown in a deployed position. In the deployed position, the retractable support 60 and the wheels 36 of the running gear system 12 cooperatively support the weight of the case 14 and its contents. To retract the retractable support 60, the support legs 64 may be pivoted toward the bars 62 of the running gear system 12. In certain embodiments, the support legs 64 may have a U-shaped configuration that enables the support legs 64 to wrap around the bars 62 in the retracted configuration. In other words, the bars 62 may be nested in the support legs 64 when the retractable support 60 is in the retracted position.

The retractable support 60 may have additional features to improve operation of the retractable support 60. For example, the retain the retractable support 60 in the deployed or retracted position, each of the support legs 64 may have one or more ball dents 70 that engage with respective ball dents formed in the bars 62. Furthermore, the retractable support 60 maybe susceptible to various modifications in certain embodiments. For example, while the illustrated embodiment shows the retractable support 60 coupled to the bars 62, in other embodiments the retractable support 60 may couple to, and pivot about, the stem 44 of the running gear system. In another embodiment, the stem 44 of the running gear system 12 may be configured to bend or rotate. In such an embodiment, the stem 44 and the handle 40 may function as the retractable support 60.

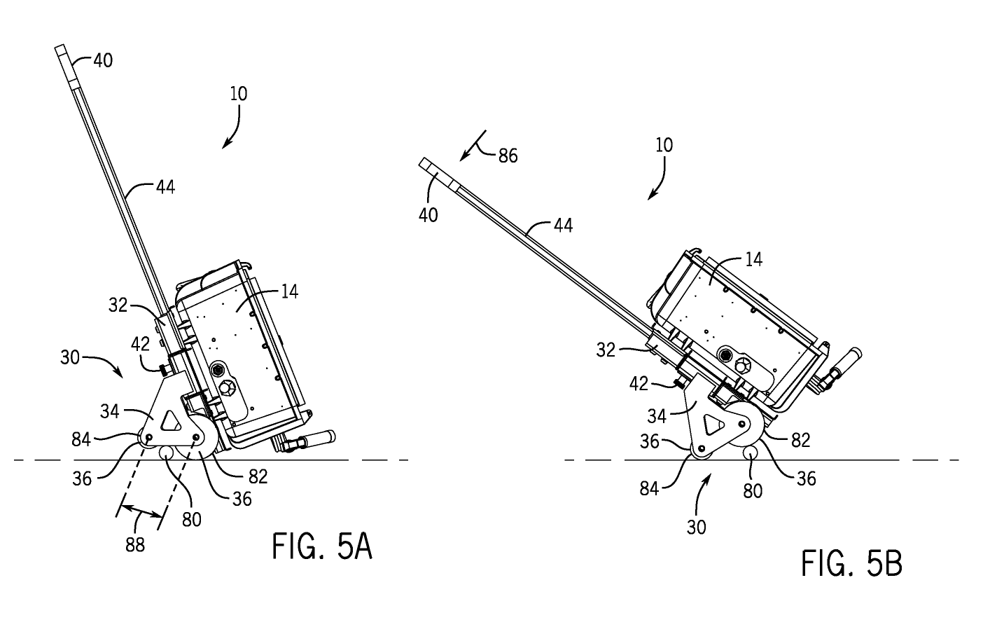

FIGS. 5A and 5B are side perspective views of the portable wire feeder system 10, illustrating operation of the running gear system 12. In particular, the illustrated embodiments show the traversal of the portable wire feeder system 10 over an obstacle (e.g., a cable 80).

As discussed in detail above, each of the wheel assemblies 30 of the running gear system 12 may include multiple wheels 36. In the illustrated embodiment, each wheel assembly 30 has two wheels 36, i.e., a first wheel 82 and a second wheel 84. The first wheels 82 of each wheel assembly 30 are of sufficient size to enable the case 14 with the running gear system 12 to roll over various obstacles that may exist in a working environment, such as small cables, debris, etc.

However, while transferring the portable wire feeder system 10 from one location to another, an operator or user may occasionally encounter an obstacle (e.g., the larger cable 80) that cannot easily be traversed by the first wheels 84. In such a circumstance, the user or operator may pivot the portable wire feeder system 10 about the obstacle (e.g., the cable 80) and transfer weight of the case 14 to the second wheels 84 of the wheel assemblies 30. For example, as shown in FIG. 5A, the user or operator may approach the cable 80 with the portable wire feeder system 10 rolling on the first wheels 82. When the first wheels 82 reach or abut the cable 80, the user or operator may apply a force on the handle 44, as indicated by arrow 86 in FIG. 5B. In this manner, the operator or user may pivot the portable wire feeder system 10 about the cable 80 to transfer weight of the portable wire feeder system 10 to the second wheels 84. The portable wire feeder system 10 may then be rolled away from the cable 80 on the second wheels 84. Thereafter, the portable wire feeder system 10 may be pivoted to transfer weight of the portable wire feeder system 10 back to the first wheels 82, and the operator or user may continue transferring the portable wire feeder system 10 to another location.

In the illustrated embodiment, the first wheels 82 are larger than the second wheels 84. For example, a ratio of size between the first wheels 82 and the second wheels 84 may be approximately 2:1, 3:1, 4:1, 5:1, or any other suitable ratio. In other embodiments, the first wheels 82 and the second wheels 84 may be the same size. Additionally, the spacing (e.g., distance 88) between the first and second wheels 82 and 84 may vary in different embodiments.

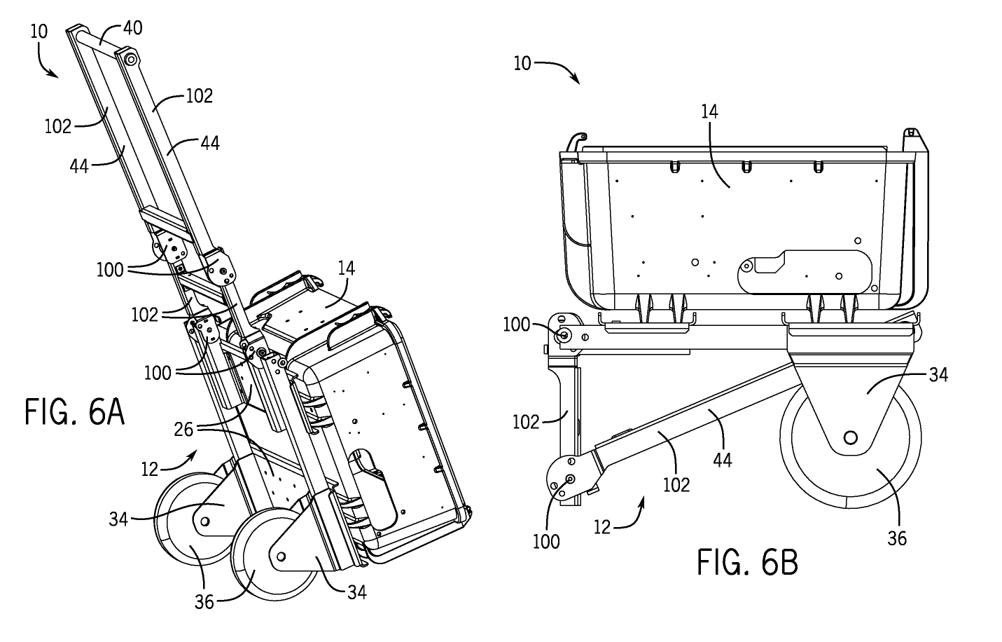

FIGS. 6A-6B are views of the portable wire feeder system 10, illustrating another embodiment of the running gear system 12. Specifically, FIG. 6A is a perspective view of the portable wire feeder system 10, illustrating the running gear system 12 having two rotatable stems 44. As mentioned above, in certain embodiments, the stem 44 or stems 44 may be configured to bend or pivot and function as a stand in place of the retractable support 60. For example, as shown in FIG. 6A, the stems 44 have multiple hinges 100 that enable pivoting of the stems 44. In other words, multiple segments 102 of the stems 44 are coupled to one another by the hinges 100 to enable rotation of the segments 102 relative to one another. As a result, the stems 44 may be collapsed (i.e., the segments 102 of the stems 44 rotate relative to one another) and configured to cooperatively support the case 14 with the wheels 36 in a horizontal configuration. For example, FIG. 6B illustrates a side view of the portable wire feeder system 10, illustrating the stems 44 in a collapsed configuration. In the collapsed configuration, the stems 44 and the wheels 36 support the case 14 in a horizontal configuration. As a result, the illustrated embodiment may not include the retractable support 60 shown in FIG. 4.

As discussed in detail above, present embodiments are directed to the wire feeder running gear system 12 that enables a user to transport the wire feeder case 14 from one location to another. The running gear system 12 has a number of embodiments each including a track or “dolly” system that couples to the case 14 of the wire feeder to enable transfer of the case 14 from one location to another. For example, the track system includes brackets 24 that attach a plurality of wheel assemblies 30 to the wire feeder case 14. Additionally, the wheel assemblies 30 are configured to rotate and lock between a deployed position and a retracted position. During transfer of the case 14 from one location to another, the wheel assemblies 30 may be rotated outward and locked in the deployed position to enable use of the running gear system 12 as a dolly or hand truck. When storing or placing the case 14 in a more limited space, the wheel assemblies 30 may be rotated inward and locked in a retracted position. Furthermore, the running gear system 12 may include the handle 40 and stem 44 that may be extended and used when the running gear system 12 is in the deployed position and the case 14 is transferred from one location to another. Additionally, the running gear system 12 may include the retractable support 60 or “kickstand” to enable support of the case 14 in a horizontal position. Furthermore, in certain embodiments, each of the wheel assemblies 30 of the running gear system 12 may include multiple wheels 36 configured to enable pivoting of the case 14 and running gear system 12 over obstacles or other hindrances while transferring (e.g., rolling) the case 14 from one location to another.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
a portable wire feeder running gear system, comprising:
at least one bracket configured to removably couple to a case of a portable wire feeder; and
a plurality of wheel assemblies coupled to the at least one bracket, wherein each of the plurality of wheel assemblies is configured to rotate between a first retracted position and a first deployed position.

2. The system of claim 1, wherein the portable wire feeder running gear system comprises a handle configured extend between a second retracted position and a second deployed position.

3. The system of claim 2, wherein the handle comprises a stem coupled to the at least one bracket, where in the stem comprises a plurality of telescopic segments nested within one another.

4. The system of claim 1, wherein the at least one bracket is configured to couple to a plurality of external rails formed on a side of the case.

5. The system of claim 1, wherein the portable wire feeder running gear system comprises a plurality of spring loaded knobs, wherein each of the plurality of spring loaded knobs is configured to lock a respective one of the plurality of wheel assemblies in the first retracted position and the first deployed position.

6. The system of claim 1, wherein each of the plurality of wheel assemblies comprises a first wheel and a second wheel.

7. The system of claim 6, wherein the first wheel and the second wheel are captured by two wheel brackets, wherein each of the wheel brackets comprises a triangular shape.

8. The system of claim 7, wherein the first wheel is at least twice as large as the second wheel.

9. The system of claim 1, wherein the portable wire feeder running gear system comprises a retractable support configured to rotate between a second retracted position and a second deployed position, wherein the retractable support is co-planar with the at least one mounting bracket in the second retracted position, the retractable support is disposed at an approximately 90 degree angle relative to the at least one mounting bracket in the second deployed position.

10. A system, comprising:
a portable wire feeder case; and
a running gear system removably coupled to the portable wire feeder case, wherein the running gear system comprises:
a plurality of wheel assemblies;
an extendable handle; and
a retractable support, wherein the plurality of wheel assemblies and the retractable support are configured to cooperatively support the portable wire feeder case in a horizontal orientation.

11. The system of claim 10, wherein each of the plurality of wheel assemblies is configured to rotate between a first retracted position and a first deployed position.

12. The system of claim 11, wherein each of the plurality of wheel assemblies is co-planar with the portable wire feeder case in the first retracted position, and each of the plurality of wheel assemblies is disposed at an approximately 90 degree angle relative to the portable wire feeder case in the first deployed position.

13. The system of claim 10, wherein the portable wire feeder cases comprises a plurality of integrally formed external rails extending across a rear side of the portable wire feeder case, and the running gear system comprises a plurality of mounting brackets configured to couple the plurality of wheel assemblies to the plurality of integrally formed rails.

14. The system of claim 10, wherein the extendable handle comprises a stem comprising a plurality of telescopic segments nested within one another.

15. The system of claim 10, wherein each of the plurality of wheel assemblies comprises two wheels radially offset from one another.

16. A system, comprising:
a running gear system configured to couple to a portable wire feeder case, wherein the running gear system comprises:
a plurality of wheel assemblies configured to rotate between a first retracted position and a first deployed position;
a handle configured to extend between a second retracted position and a second deployed position; and
a retractable support, wherein the plurality of wheel assemblies and the retractable support are configured to cooperatively support the portable wire feeder case in a horizontal orientation.

17. The system of claim 16, wherein the running gear system comprises at least one bracket configured to couple the plurality of wheel assemblies, the handle, and the retractable support to integrally formed external rails of the portable wire feeder case.

18. The system of claim 16, wherein the running gear system comprises a plurality of spring loaded knobs, wherein each of the plurality of spring loaded knobs is configured to lock a respective one of the plurality of wheel assemblies in the first retracted position and the first deployed position.

19. The system of claim 16, wherein the retractable support comprises two support legs and a cross brace extending between the two support legs, and wherein the retractable support is configured to rotate between a second retracted position and a second deployed position, wherein the retractable support is co-planar with the running gear system in the second retracted position, the retractable support is disposed at an approximately 90 degree angle relative to the running gear system in the second deployed position.

20. The system of claim 16, wherein each of the plurality of wheel assemblies comprises a first wheel and a second wheel, the first wheel and the second wheel are captured by two wheel brackets, each of the wheel brackets comprises a triangular shape, and the first wheel is at least twice as large as the second wheel.
